(19) United States
(12) Patent Application Publication
(10) Pub. No.: US 2004/0080830 A1
(43) Pub. Date: Apr. 29, 2004

(54) Niobium oxide and silicon dioxide thin film filter for dense wavelength division multiplexing

(76) Inventors: Charles Leu, Fremont, CA (US); Ga-Lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/407,527

(22) Filed: Apr. 3, 2003

(30) Foreign Application Priority Data
Oct. 25, 2002 (TW) 91124860

(51) Int. Cl. G02B 5/18; G02B 27/42

(52) U.S. Cl. 359/558

(57) ABSTRACT

A DWDM thin film filter includes a glass substrate (11) and a film stack (12). The film stack includes a plurality of cavities (13). Each cavity includes a first group of mirror layers (21), a second group of mirror layers (22), and a spacer layer (23). Each group of mirror layers includes a plurality of high refractive index thin films (31) and low refractive index thin films (32) alternately deposited one on another. The material of the high refractive index films is a composition of niobium oxide, namely Nb₂O_{5-X}. The value of x ranges from 0 to 0.5, which yields a refractive index ranging from 2.15 to 2.40. A thin film filter having 140 layers of film can be produced according to the preferred embodiment. Such thin film filter attains the same or better optical characteristics compared to a conventional DWDM thin film filter having 180 layers of film.

### BACKGROUND OF THE INVENTION

1. Field of the Invention

The present invention relates to dense wavelength division multiplexing (DWDM) thin film filters, and particularly to the composition of layers of high refractive index thin films of such thin film filters.

2. Description of Related Art

A DWDM thin film filter comprises a multi-cavity film stack which is deposited on a glass substrate.

U.S. Pat. No. 6,215,592 discloses an optical thin film filter having broad resonant frequency passbands for filtering an optical input, including a plurality of multiplexed optical wavelengths in a first set of transmitted wavelengths and a second set of reflected wavelengths. The filter has first and second inner mirrors separated substantially by an inner spacer, a first outer mirror separated from the first inner mirror substantially by a first outer spacer, and a second outer mirror separated from the second inner mirror substantially by a second outer spacer. The inner mirrors have a reflectivity which is greater than the reflectivity of the outer mirrors. Each inner mirror comprises dielectric layers of high refractive index material and dielectric layers of low refractive index material, alternately deposited one on another to form a stack. In the optical thin film filter, each of the layers in the first and second inner mirrors and in the first and second outer mirrors is generally comprised of one of the following materials: silicon dioxide (SiO₂), tantalum pentoxide (Ta₂O₅), titanium dioxide (TiO₂), aluminum oxide (Al₂O₃), hafnium dioxide (HfO₂), and zirconium dioxide (ZrO₂).

The odd and even numbered standard International Telecommunications Union (ITU) channels of the above-mentioned optical thin film filter are separated by a frequency spacing of 200 GHz. Modem optical thin film filters are increasingly being required to have channel spacings of 100 GHz, 50 GHz or even less. Accordingly, larger numbers of cavities in optical filters are required to meet the increasingly demanding requirements relating to pass bandwidth and isolation bandwidth. Internal stress is intrinsic to multilayer optical thin film filters and to the film deposition process involving large numbers of cavities in a film stack. Generally, a larger number of cavities increases internal stress of an optical thin film filter. This frequently results in higher rates of failure during manufacture and in use, and unacceptably high insertion loss of the optical thin film filters.

### SUMMARY OF THE INVENTION

In view of the above, an object of the present invention is to provide a thin film stack of a DWDM thin film filter which has relatively few layers of film and less internal stress.

Another object of the present invention is to provide a DWDM thin film filter which is relatively simple and inexpensive to manufacture.

A further object of the present invention is to provide a thin film filter which is relatively resistant to failure during manufacture and in use.

To achieve the above objects, a DWDM thin film filter in accordance with the present invention comprises a glass substrate and a film stack. The film stack comprises a plurality of cavities. Each cavity comprises a first group of mirror layers, a second group of mirror layers, and a spacer layer. Each group of mirror layers comprises a plurality of high refractive index thin films and low refractive index thin films alternately deposited one on another. The material of the high refractive index films is a composition of niobium oxide, namely Nb₂O_{5-X}. The value of x ranges from 0 to 0.5, which yields a refractive index ranging from 2.15 to 2.40. A thin film filter which has 140 layers of film can be produced according to the preferred embodiment. Such thin film filter attains the same or better optical characteristics compared to a conventional DWDM thin film filter having 180 layers of film.

Other objects, advantages and novel features of the invention will become more apparent from the following detailed description when taken in conjunction with the accompanying drawings, in which:

### BRIEF DESCRIPTION OF THE DRAWINGS

FIG. 1 is a cross-sectional view of a thin film filter in accordance with the present invention;

FIG. 2 is a schematic side view of a cavity of the thin film filter of FIG. 1;

FIG. 3 is a graph of transmittance versus wavelength for a thin film filter having 140 layers of film made according to the present invention; and

FIG. 4 is a graph of transmittance versus wavelength for a conventional tantalum oxide thin film filter having 180 film layers.

### DETAILED DESCRIPTION OF PREFERRED EMBODIMENT OF THE PRESENT INVENTION

It is to be understood that the figures as described above have been simplified. Some elements have been drawn out of proportion to illustrate those aspects of the structure of a thin film filter that are relevant for a clear understanding of the present invention. Reference will now be made to the drawings to describe a preferred embodiment of the present invention in detail.

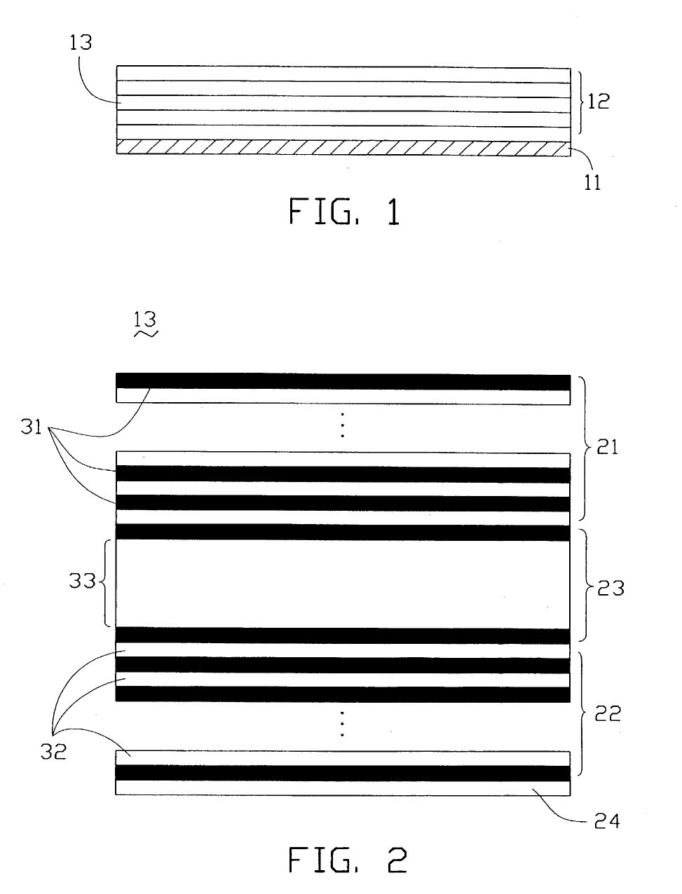

Referring to FIG. 1, a thin film filter for dense wavelength division multiplexing in accordance with the present invention comprises a glass substrate 11 and a film stack 12. The film stack 12 comprises five cavities 13, and is deposited on the glass substrate 11. Referring to FIG. 2, each cavity 13 comprises a first group of mirror layers 21, a second group of mirror layers 22, and a spacer layer 23 between the first and second groups of mirror layers 21, 22. The structure of each cavity 13 is (HL)^{m}H(yL)H(LH)^{m}C, where m is an integer and y is an even number. The symbol H represents a high refractive index thin film. The symbol L represents a low refractive index thin film. The symbol C represents a coupling film 24 that adjoins an adjacent cavity 13. The coupling film 24 is normally made of a material having a relatively low refractive index. Values of m and of y in any one cavity 13 may be different from values of m and of y in any other cavity 13.

Each group of mirror layers 21, 22 comprises a plurality of high refractive index thin films 31 and a plurality of low refractive index thin films 32. The high and low refractive index films 31, 32 are alternately deposited one on another. As shown above, the structure of each group of mirror layers 21, 22 is (HL)^{m} and (LH)^{m} respectively, where m is an integer. A thickness of each high refractive index film 31 and of each low refractive index film 32 is equal to a quarter of a central wavelength of a pass bandwidth of the thin film filter. Generally, the number of cavities of a thin film filter is key to determining its pass band shape, while the reflectivity of its groups of mirror layers determine the transmittance of the thin film filter. Two parameters are adjusted to obtain a desired reflectivity. The first parameter is the number of films in each group of mirror layers. The second parameter is the difference between the refractive indices of the high refractive index films and the low refractive index films within each group of mirror layers. The material of the low refractive index films L can be silicon dioxide (SiO₂) or aluminum oxide (Al₂O₃). In the preferred embodiment, silicon dioxide is used. Silicon dioxide has a refractive index of 1.46. In the preferred embodiment, the material of the high refractive index films H is a composition of niobium oxide, namely Nb₂O_{5-X}. In the preferred embodiment, the value of x ranges from 0 to 0.5. This yields a refractive index ranging from 2.15 to 2.40, which is higher than refractive indices of materials conventionally used in high refractive index films. For example, tantalum pentoxide has a refractive index of just 2.0. Thus a desired reflectivity can be attained using fewer films.

As shown above, the structure of each spacer layer 23 is H(yL)H, where y is an even number. The optical thickness of each low refractive index film 32 is equal to a quarter of the central wavelength of the pass bandwidth of the thin film filter. Accordingly, a low refractive index layer 33 of the spacer layer 23 has an optical thickness equal to y times a quarter of the central wavelength of the pass bandwidth of the thin film filter. The optical thickness of each high refractive index film 31 is equal to a quarter of the central wavelength of the pass bandwidth of the thin film filter. Accordingly, the spacer layer 23 has an optical thickness equal to y+2 times a quarter of the central wavelength of the pass bandwidth of the thin film filter.

The glass substrate 11 is transparent to wavelengths under which the thin film filter operates. The glass substrate 11 may alternatively be made from a wide variety of materials including quartz, optical plastic, silicon, and germanium.

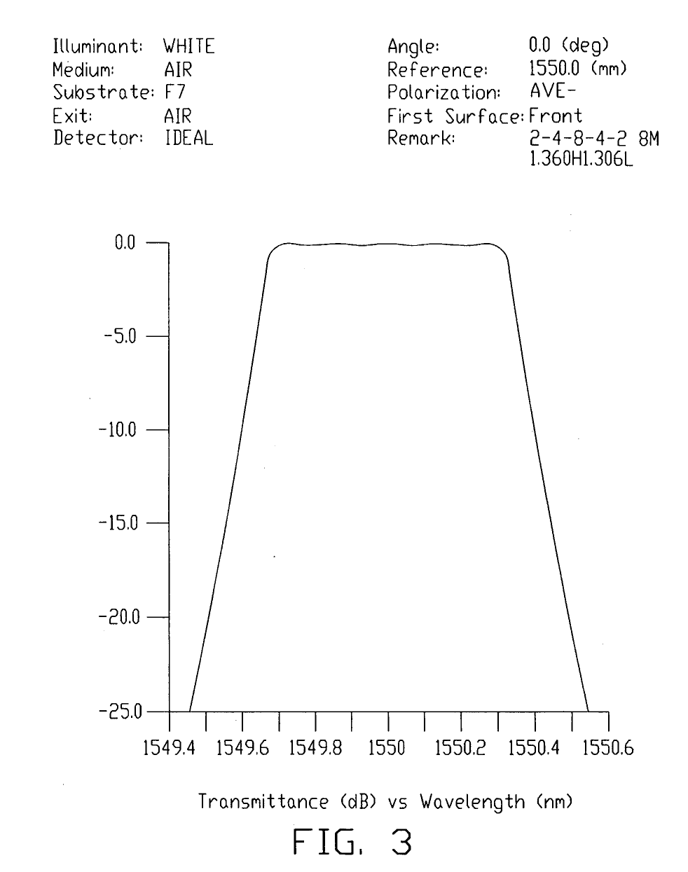

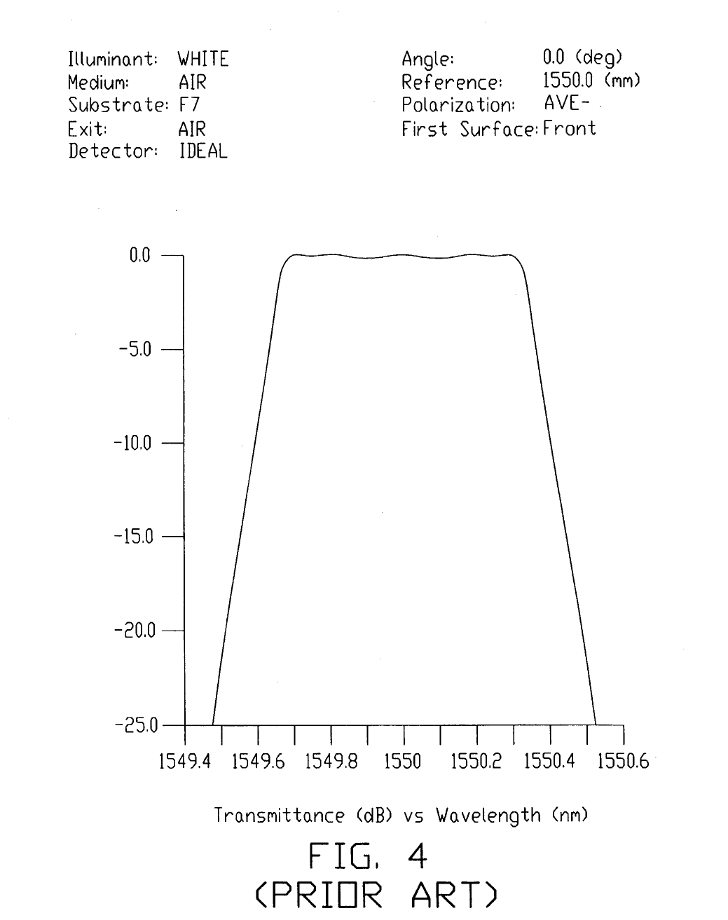

A thin film filter which has 140 layers of film can be produced according to the preferred embodiment. This thin film filter attains the same or better optical characteristics compared to a conventional DWDM thin film filter having 180 layers of film. Comparing the data of FIG. 3 with those of FIG. 4, the thin film filter of the present invention has a pass bandwidth (1.088 nm at 25 dB) similar to that of the conventional thin film filter (1.066 nm at 25 dB). In addition, compared to the conventional thin film filter, the thin film filter of the present invention yields a waveform closer to an ideal waveform having no variation. The thin film filter of the present invention also achieves much better insertion loss due to much less film stress.

It is to be understood that the above-described preferred embodiment of the present invention is intended to exemplify the present invention without limiting its scope. In addition, even though numerous characteristics and advantages of the present invention have been set forth in the foregoing description, together with details of the functions of the present invention, the disclosure is illustrative only. Changes may be made in detail, especially in matters of obviously similar methods, materials, processes and equipment, within the principles of the present invention to the full extent indicated by the broad general meaning of the terms in which the appended claims are expressed.

I claim:

1. A thin film filter for dense wavelength division multiplexing, the thin film filter comprising:
a substrate;
a film stack mounted on the substrate, the film stack comprising low refractive index thin films and high refractive index thin films, each of the high refractive index thin films comprising a composition of niobium oxide according to the formula Nb₂O_{5-X}, wherein a value of x ranges from 0 to 0.5.

2. The thin film filter as described in claim 1, wherein the substrate is made of material selected from the group consisting of glass, quartz, optical plastic, silicon, and germanium.

3. The thin film filter as described in claim 1, wherein the film stack comprises a plurality of cavities.

4. The thin film filter as described in claim 3, wherein each of the cavities comprises a first group of mirror layers, a second group of mirror layers, a spacer layer, and a coupling layer.

5. The thin film filter as described in claim 4, wherein each of the first and second groups of mirror layers comprises a plurality of low refractive index thin films and a plurality of high refractive index thin films.

6. The thin film filter as described in claim 4, wherein the spacer layer has an optical thickness of an even number times one-quarter of a central wavelength of a pass bandwidth of the thin film filter.

7. The thin film filter as described in claim 1, wherein the composition of niobium oxide has a refractive index ranging from 2.15 to 2.40.

8. The thin film filter as described in claim 5, wherein the low refractive index thin films comprise silicon dioxide or aluminum oxide.

9. The thin film filter as described in claim 5, wherein the low refractive index thin films and the high refractive index thin films are alternately deposited one on another.

10. The thin film filter as described in claim 5, wherein each of the low refractive index thin films and each of the high refractive index thin films has an optical thickness equal to one-quarter of a central wavelength of a pass bandwidth of the thin film filter.

11. A thin film filter for dense wavelength division multiplexing, the thin film filter comprising:
a substrate;
a film stack mounted on the substrate, the film stack comprising low refractive index thin films and high refractive index thin films, each of the high refractive index thin films comprising a composition of niobium oxide according to the formula Nb₂O_{5-X}, wherein the composition of niobium oxide has a refractive index ranging from 2.15 to 2.40.
